(19) United States
(12) Patent Application Publication
(10) Pub. No.: US 2010/0161445 A1
(43) Pub. Date: Jun. 24, 2010

(54) Pigeeback abstract consumer end user

(76) Inventors: Graeme Revell, Las Vegas, NV (US); Ashley Revell, Las Vegas, NV (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 12/231,846

(22) Filed: Dec. 23, 2008

(51) Int. Cl. G06Q 30/00; G06Q 50/00; G06F 17/30

(52) U.S. Cl. 705/27; 705/26; 707/E17.044

(57) ABSTRACT

A unique real time method by which an individual, using e-commerce may immediately, or at some other time, purchase material goods or services (product(s)), from all types of media. The media is any type of visual auditory or other sensory media now or in the future, anywhere in the universe and includes but is not limited to all types of television, radio, internet streaming, theater, concert, skywriting, billboards (static and electronic), aerial displays, jumbotrons, posters, art, DVDs, commercials, videos (online or offline), videotapes, films, videogames or printed media.

The material goods and services (product(s)) are any partial, single or multiple item made available for sale by the producers or creators of the media. The products may be included in the program material or they may be associated in any way including, but not limited to commercial advertising or sponsorship, at the discretion of the producers or creators.

### THE INVENTION

### OBJECT OF THE INVENTION

This invention is the union of two inventions, both of which are the subject of abstract here. Essentially, an individual, working through his remote, or other computer or handheld electronic device, can watch a movie or television show and interspersed advertisements on any television set, movie screen or other device, see a desirable item for purchase, and then be connected to a companion ecommerce library of potential items from an advertiser or owner of the product. The product can be purchased immediately, and all commercial activity concluded without leaving the viewing, or necessarily using a home computer.

The invention also may be available through any form of media, including but not limited to radio, live events, billboards, aerial displays, or any type of printed media

### BACKGROUND OF THE INVENTION

1. The Invention Itself

These inventions relate to ecommerce sales of products and services contained in all digital media, and also the potential use through and to radio, internet streaming, theater, billboards and any type of printed medium. As a mundane opening example, but the examples shown herein are universal (Examples 1 through 4, Consumer End User), one uses the remote control for the television, connects to the end user segment of “PiggeeBack,” chooses an item for purchase, and then is connected to the producer end for the product. The product is then purchased immediately. Let one give a description:

Let us say one is watching a mystery movie with one of one's favorite stars. One likes the coat the star is wearing and seeks to acquire it. One uses the remote to connect to the PiggeeBack system, which locates the item and then connects to the producer site, where the item exists for purchase. Without leaving the TV set, or using a computer, the purchase is made through e-commerce, sales price paid, and the product delivered.

2. Description of the Prior Art

There is no prior art comparable to the proposed inventions herein. No present system links a customer or consumer directly into a television schedule or other forms of media for the purchase of a library of items embedded in the entertainment being viewed. The “piggeeback” system enables acquiring products through use of a remote control that triggers product acquisition from the material being viewed itself, and through the television schedule directly into the producer's library of goods. The system architecture and software necessary to effectuate such a purchase has no comparable. One is also creating technology that obviates the need for computer connection and connects directly to the desired medium through portable device, home use or otherwise.

The patents or other patent related documents discovered during an opening search are non-similar, and none focus or compromise what the proposed inventions achieve. First, no other art directly ties the remote control into product acquisition. No other system in existence uses the medium of television or other media and the actual entertainment being watched to initiate the sale of items on such a distinct and precise scale. Lastly, the producer end of the patents creates a library of goods for sale directly from the entertainment itself and the mass viewing itself on a scope never before attempted. The proposed patents have no competition in known prior art and represent a vast extension and direct-purchase enablement of the practice commonly known as “product placement.”

### SUMMARY OF THE INVENTION

The multiple objectives of the two inventions herein are best described in the twin abstracts that follow. They are accompanied by drawings and by individual charts that detail the processes on both the level of the end user and the producer inputting the commerce to be sold.

The objects or objectives of the invention are multiple:
1. To create a home and mobile market for the sale of goods through any medium, without the need for the invasion of home computer;
2. To sell items through the actual product of advertisement, the entertainment being viewed, and to do so on the television platform;
3. To sell items through the actual product of advertisement, the advertisement being unlimited in scope, and the entertainment being viewed on any media platform including but not limited to live performance to billboard to DVD or any form of printed media;
4. To connect producers and distributors of products to the home and mobile market on a level and penetration never attempted.

### BRIEF DESCRIPTION OF THE DRAWINGS

FIG. 1 is a flow chart depicting the steps by which a television viewer uses the present invention for the first time.

FIG. 2 is a flow chart depicting the steps by which a television viewer uses the present invention on a subsequent occasion.

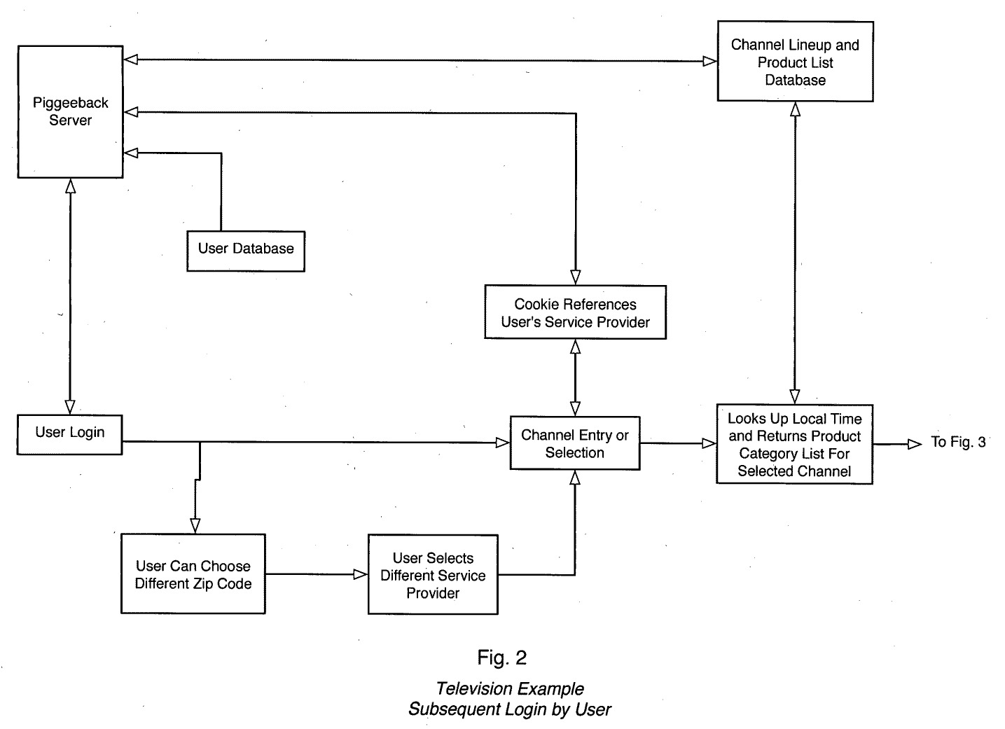

FIG. 3 is a flow chart depicting the steps by which the user selects and purchases a product using the present invention.

FIG. 4 is a flow chart depicting the steps by which a user at a live event uses the present invention.

FIG. 5 is a flow chart depicting the steps by which a user viewing a Feature Film uses the present invention.

FIG. 6 is a flow chart depicting the steps by which a user viewing a Billboard uses the present invention.

FIG. 7 is a flow chart depicting the steps by which a producer starts a Product List and Enters products into the list using the present invention.

FIG. 8 is a flow chart depicting the steps by which a producer an existing Product List and Enters products into the list using the present invention.

### DETAILED DESCRIPTION OF THE INVENTION (END USER)

The Method by which an individual may purchase products:

Step by step method examples for individual media follow.

### EXAMPLE 1

An individual is watching television (terrestrial, cable, and satellite) and desires to purchase a product (immediately or otherwise) displayed in either the program or advertising.

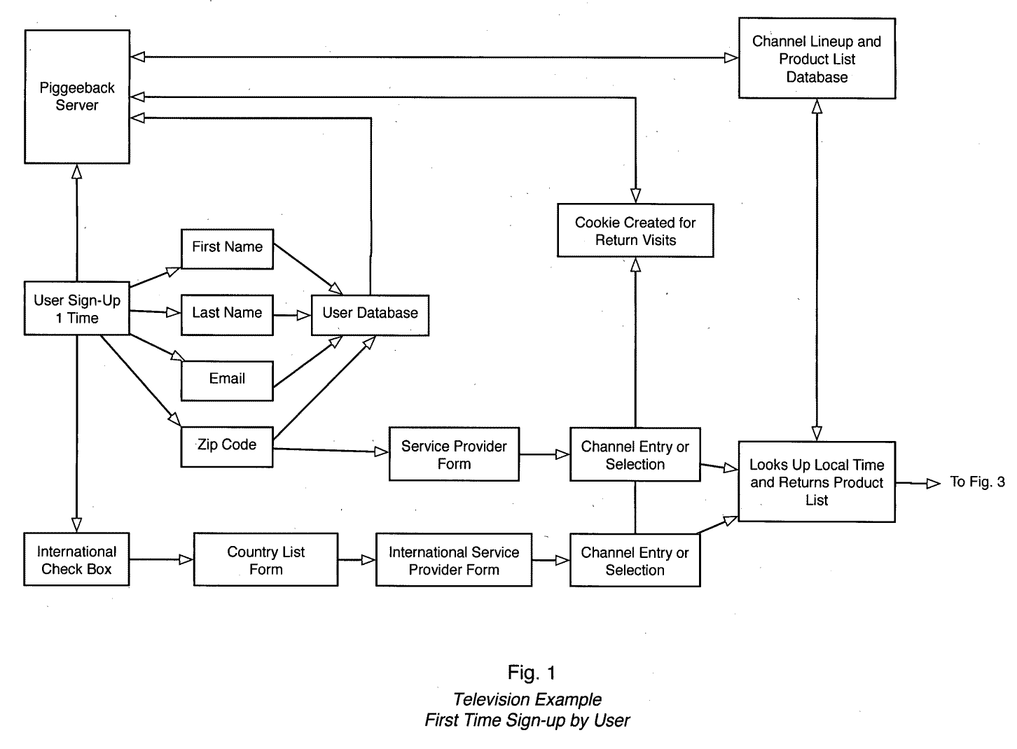

Please refer to FIGS. 1,2 and 3.

1. The individual desiring the product uses a cellphone, personal digital assistant, remote control, computer or any other device capable of connecting to the internet, to connect to the web pages on the Piggeeback server(s).

2. If the individual is visiting the Piggeeback site for the first time, they will choose “enter new zipcode” from the “home” page.

3. On the “enter new zipcode” page they will enter their name, email address and zip code in the boxes provided. If they do not reside in the United States of America they can check the “International” check box where they will be presented with a form from which they can choose their country and enter their local geographical identifiers. Whether USA or international the individual will then click on the “OK” button.

4. The “service provider” page is then loaded which contains a selection box or boxes appropriate to the previously entered geographical locator from which the individual chooses their local broadcast service provider and press “OK”. The Piggeeback server then records a “cookie” in the individual's web browser which makes it possible for the individual to skip the “home”, “enter new zipcode” and “service provider” pages on subsequent connections to the Piggeeback server.

5. Once the “OK” button in 4 has been pressed, the “channel selection” page is then loaded which contains a selection box or boxes appropriate to the previously selected service provider from which they can select the channel or frequency broadcasting the current program and press. “OK”.

6. The “product category” page is loaded which contains a selection box labeled “in the show” and a selection box labeled “in the commercials” from which the individual can select the category appropriate to the item or service they wish to purchase.

7. After selecting the category, the “product” page containing the product of interest is loaded which allows the individual to choose the product and press “add to cart”. There may, or may not be additional steps involved in choosing the product, for example in the case of a fashion item, retailer, color, size and style may be selected on one or more additional pages.

8. Once “add to cart” has been pressed, the online store page is loaded allowing the individual to finalize the purchase of the product using standard e-commerce payment and delivery methods.

### EXAMPLE 2

An individual attending a live event or display (for example a concert, theater or jumbotron display) desires to purchase a product (immediately or otherwise) displayed or mentioned in the live event or display:

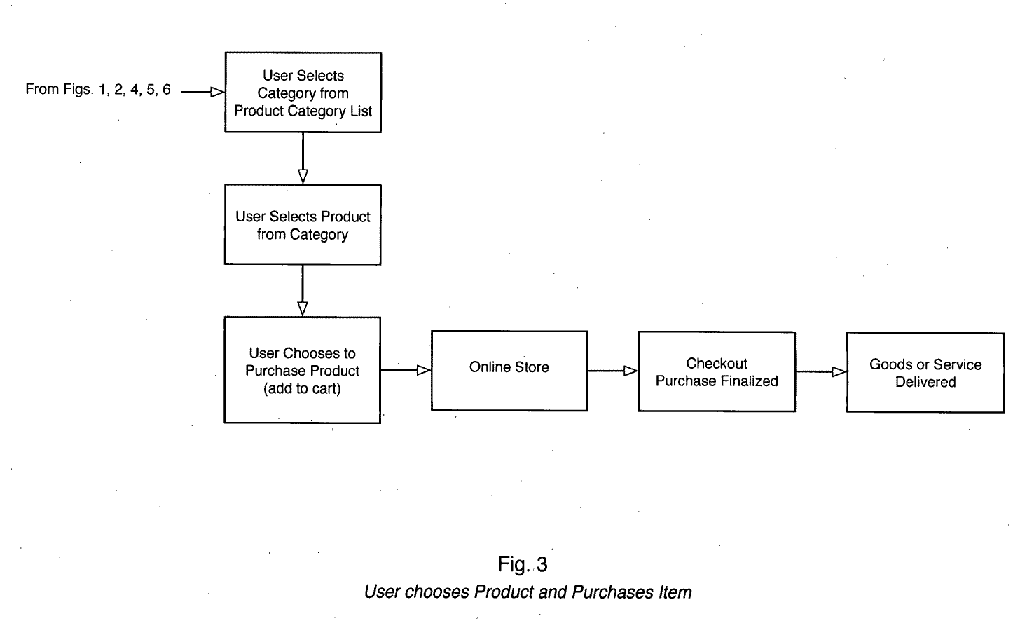

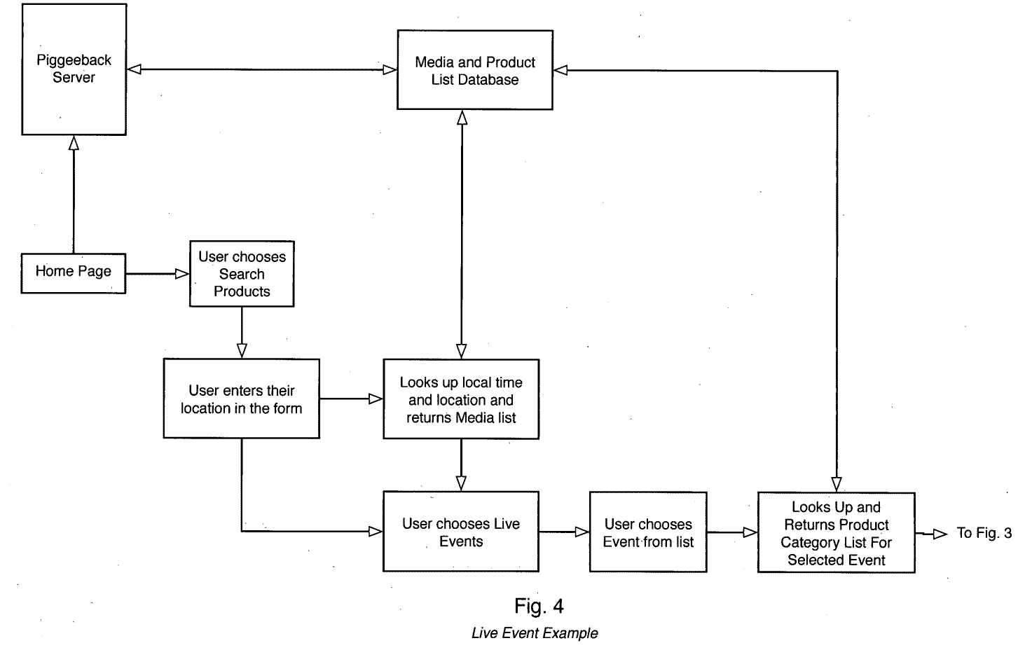

Please refer to FIGS. 4 and 3.

1. The individual desiring the product uses a cellphone, personal digital assistant, remote control, computer or any other device capable of connecting to the internet, to connect to the web pages on the Piggeeback server.

2. The individual selects “search products” from the “home” page.

3. The “search products” page is loaded with a form which allows the individual to input a geographical location. A results page is automatically generated listing all media in the Piggeeback database currently relevant to that location.

4. The individual selects the live event.

5. The “live event” page is loaded and the individual selects the appropriate event.

6. The “product category” page for that event is loaded which contains a selection box labeled “in the show” and a selection box labeled “in the commercials” from which the individual can select the category appropriate to the item or service they wish to purchase.

7. After selecting the category, the “product” page containing the product of interest is loaded which allows the individual to choose the product and press “add to cart”. There may, or may not be additional steps involved in choosing the product, for example in the case of a fashion item, retailer, color, size and style may be selected on one or more additional pages.

8. Once “add to cart” has been pressed, the online store page is loaded allowing the individual to finalize the purchase of the product using standard e-commerce payment and delivery methods.

### EXAMPLE 3

An individual watching a feature film at a cinema desires to purchase a product (immediately or otherwise) displayed or mentioned in the film or associated advertisements or sponsorship. The following point by point method example applies to all pre-recorded media and streams mentioned in the abstract with minor variations.

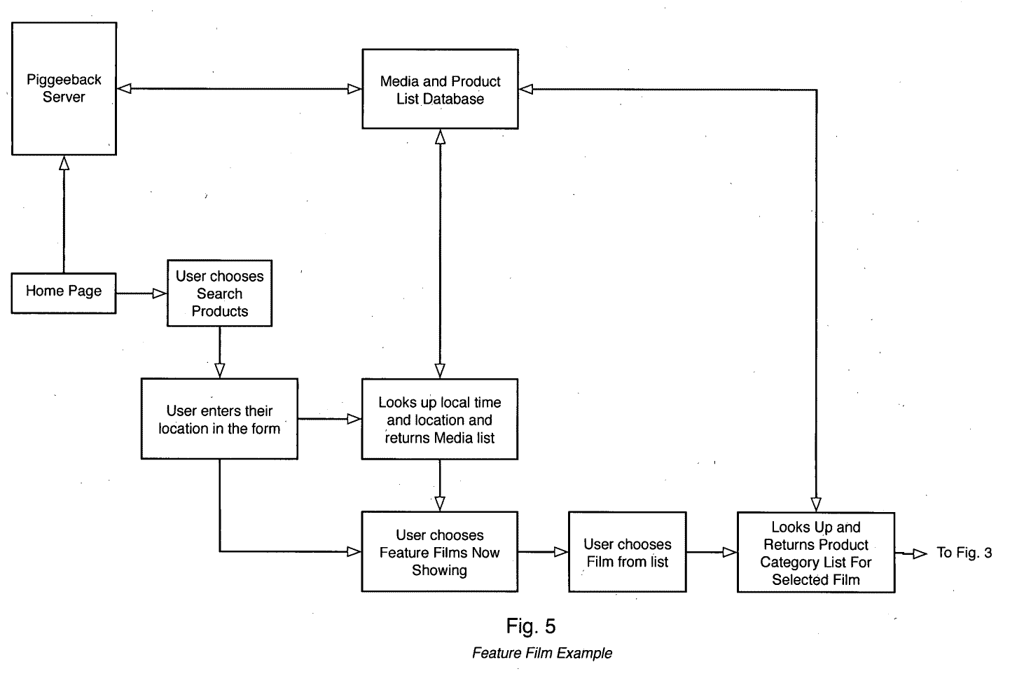

Please refer to FIGS. 5 and 3.

1. The individual desiring the product uses a cellphone, personal digital assistant, remote control, computer or any other device capable of connecting to the internet, to connect to the web pages on the Piggeeback server.

2. The individual selects “search products” from the “home” page.

3. The “search products” page is loaded with a form which allows the individual to input a geographical location. A results page is automatically generated listing all media in the Piggeeback database currently relevant to that location.

4. The individual selects “feature films now showing” from the list of medium provided.

5. The “feature films now showing” page is loaded listing feature films currently screening in that location. The individual chooses the film from which they wish to purchase a product.

6. The “product category” page for that film is loaded which contains a selection box labeled “in the show” and a selection box labeled “in the commercials” from which the individual can select the category appropriate to the item or service they wish to purchase.

7. After selecting the category, the “product” page containing the product of interest is loaded which allows the individual to choose the product and press “add to cart”. There may, or may not be additional steps involved in choosing the product, for example in the case of a fashion item, retailer, color, size and style may be selected on one or more additional pages.

8. Once “add to cart” has been pressed, the online store page is loaded allowing the individual to finalize the purchase of the product using standard e-commerce payment and delivery methods.

### EXAMPLE 4

An individual seeing a billboard or printed media desires to purchase a product displayed on the billboard or printed media:

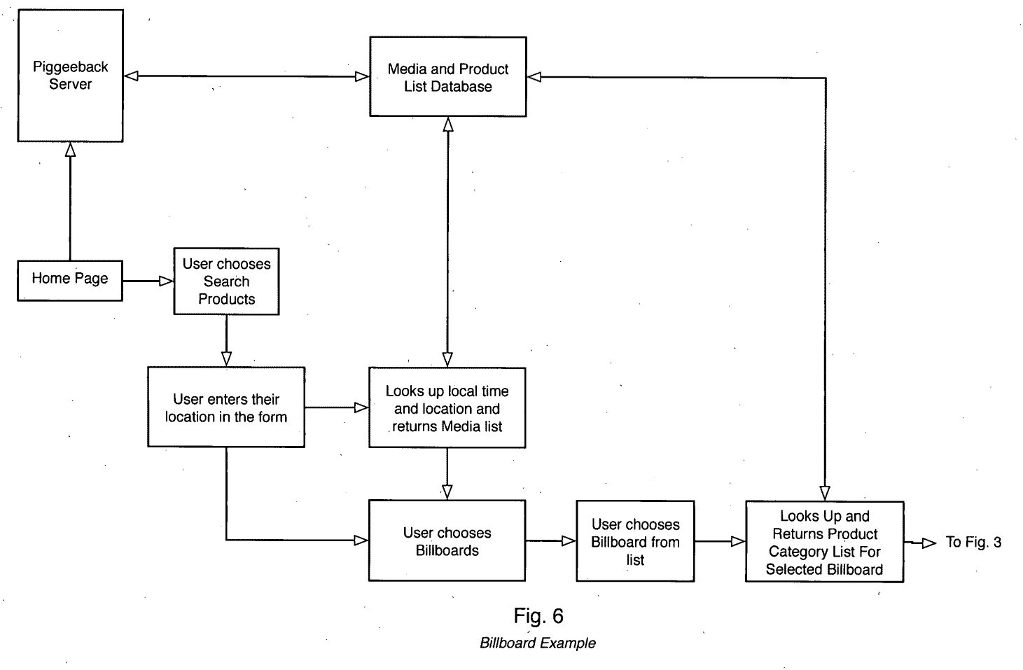

Please refer to FIGS. 6 and 3.

1. The individual desiring the product uses a cellphone, personal digital assistant, remote control, computer or any other device capable of connecting to the internet, to connect to the web pages on the Piggeeback server.

2. The individual selects “search products” from the “home” page.

3. The “search products” page is loaded with a form which allows the individual to input a geographical location. A results page is automatically generated listing all media in the Piggeeback database currently relevant to that location.

4. The individual selects “billboard”.

5. The “billboard” page is loaded and the individual selects the appropriate billboard.

6. The “product category” page for that billboard is loaded which contains a selection box listing the product categories displayed on the billboard from which the individual can select the category appropriate to the item or service they wish to purchase.

7. After selecting the category, the “product” page containing the product of interest is loaded which allows the individual to choose the product and press “add to cart”. There may, or may not be additional steps involved in choosing the product, for example in the case of a fashion item, retailer, color, size and style may be selected on one or more additional pages.

8. Once “add to cart” has been pressed, the online store page is loaded allowing the individual to finalize the purchase of the product using standard e-commerce payment and delivery methods.

### DETAILED DESCRIPTION OF THE INVENTION (PRODUCER)

The method for the Producer or Creator to add products to the database:

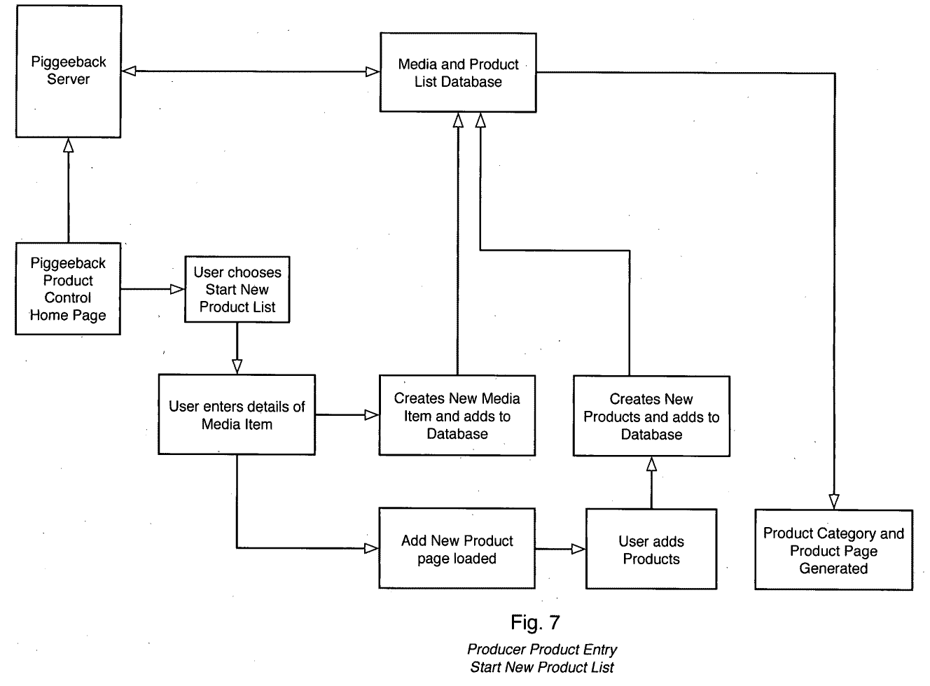

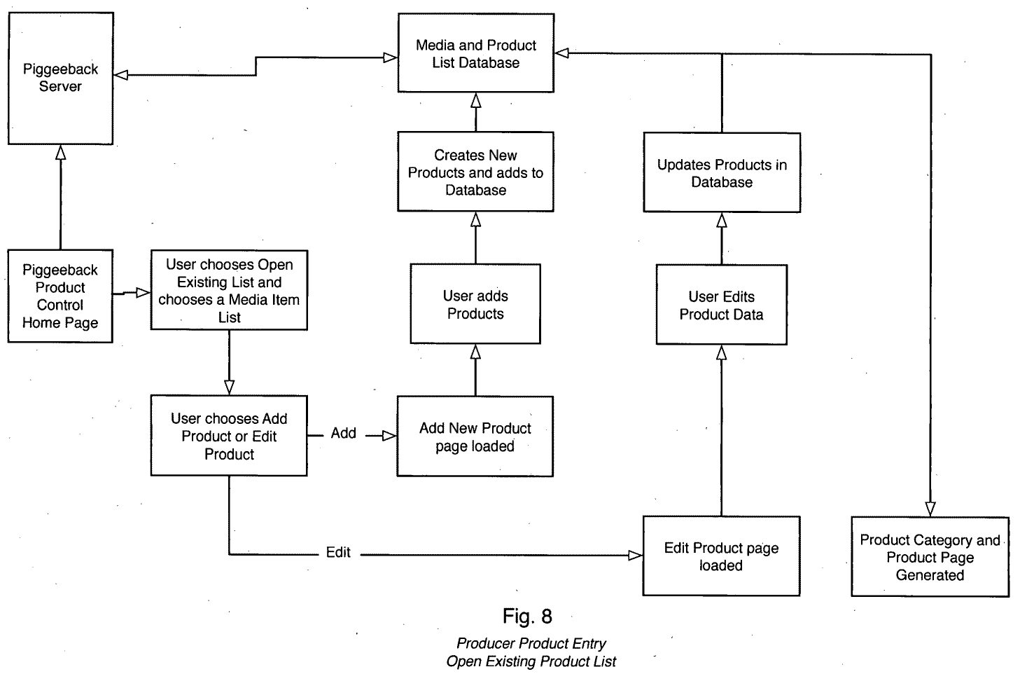

Please refer to FIGS. 7 and 8.

1. The producer uses a computer or any other device capable of connecting to the internet, to connect to the “Piggeeback Product Control” web pages on the Piggeeback server.

2. The producer “home” page is loaded. The producer selects either “start a new product list” or “open existing list”.

3. If the producer selects “start a new product list”, the “media details” page is loaded. The producer then enters the show title, episode title, season number, episode number, program identification number, air date and any other relevant information into the form provided. They then click “create media”.

4. The “product entry” page is loaded for that media and the producer enters the name, manufacturer, price, category, cart ranking number, entry date, episode title, description, image and any other relevant information into the form provided. They then click “add product”. The product is added to the database and a “product category” page and “product” page is automatically generated. The product is also given a unique serial number based on the media identification number.

5. If the producer selects “open existing list”, the “media list” page is loaded and the producer chooses the media and product list they wish to modify.

6. The media “product list” page is loaded and the producer chooses to either edit an existing product or add a new product.

7. If they choose “add product” the “product entry” page is loaded for that media item and the producer enters the name, manufacturer, price, category, cart ranking number, entry date, episode title, description, image and any other relevant information into the form provided. They then click “add product”. The product is added to the database and a “product category” page and “product” page is automatically generated.

8. If they choose “edit product” the “edit product” page is loaded and the producer modifies the relevant product information and chooses “save”.

9. The updated product information is saved to the database and the corresponding “product category” page and “product” page is automatically updated.

What is claimed is:

1. A unique real time method by which an individual, using e-commerce may immediately, or at some other time, purchase material goods or services (hereinafter “product(s)”), from all types of media, comprising the steps of:
a) using a cellular phone, personal digital assistant, remote control, computer or any other device capable of connecting to the internet or other server network;
b) connecting to a central website (“piggeeback.com” or similar) containing an aggregated library of products for sale;
c) entering personal information for the purposes of geographical location;
d) selecting the appropriate medium;
e) searching for the desired product;
f) purchasing the desired product.

2. The method of claim 1, including, if the individual is visiting the Piggeeback site for the first time, choosing “enter new zipcode” or selecting among international address options from the “home” page.

3. The method of claim 1, including automatic loading of the “service provider” page which contains a selection box or boxes appropriate to the previously entered geographical locator from which the individual chooses his local broadcast service provider.

4. The method of claim 3, wherein the Piggeeback server then records a “cookie” in the individual's web browser which makes it possible for the individual to skip the “home”, “enter new zipcode” and “service provider” pages on subsequent connections to the Piggeeback server.

5. The method of claim 1, including automatic loading of the “channel selection” page which contains a selection box or boxes appropriate to the previously selected service provider from which they can select the channel or frequency broadcasting the current program.

6. The method of claim 1, including automatic loading of the “product category” page which contains a selection box labeled “in the show” and a selection box labeled “in the commercials” from which the individual can select the category appropriate to the item or service they wish to purchase.

7. The method of claim 6, wherein after selecting the category, the “product” page containing the product of interest is automatically loaded which allows the individual to choose the product and press “add to cart”. There may, or may not be additional steps involved in choosing the product.

8. The method of claim 1, including the automatic loading of the online store page allowing the individual to finalize the purchase of the product using standard e-commerce payment and delivery methods.

9. The method of claim 1, including a method of searching for products (a search engine) when the source channel is unknown to the consumer, facilitating the consumer to “search products”.

10. The method of claim 9, whereby the “products” page of all similar products is automatically loaded and includes source information and allows the individual to choose the product and press “add to cart”.

11. The method of claims 1 through 10, including application of the system and methods to all media in addition to television including, but not limited to, radio, internet streaming, videogames, live events, theater, concerts, skywriting, billboards (static and electronic), aerial displays, jumbotrons, posters, art, DVDs, commercials, videos (online or offline), videotapes, films (private or public screening) or any type of printed media.
